(19) United States
(12) Patent Application Publication
(10) Pub. No.: US 2021/0341615 A1
(43) Pub. Date: Nov. 4, 2021

(54) METHOD FOR ADJUSTING ELECTROMAGNETIC WAVE DETECTING DEVICE, ELECTROMAGNETIC WAVE DETECTING DEVICE, AND INFORMATION ACQUIRING SYSTEM

(71) Applicant: KYOCERA Corporation, Kyoto (JP)

(72) Inventor: Eri TAKEUCHI, Yokohama-shi, Kanagawa (JP)

(73) Assignee: KYOCERA Corporation, Kyoto (JP)

(21) Appl. No.: 17/273,913

(22) PCT Filed: Sep. 2, 2019
(86) PCT No.: PCT/JP2019/034466

§ 371 Date: Mar. 5, 2021

(30) Foreign Application Priority Data
Sep. 10, 2018 (JP) 2018-168938

(51) Int. Cl. G01S 17/89; G01S 7/481; G02B 26/10; G02B 26/08

(52) U.S. Cl. CPC G01S 17/89; G02B 26/0833; G02B 26/10; G01S 7/4817

(57) ABSTRACT

An electromagnetic wave detecting device comprises: a first image forming part configured to form an image of electromagnetic waves incident from a detection object; a traveling part including a reference plane and configured to cause electromagnetic waves incident from the first image forming part to the reference plane, to travel in a first direction; and a first detector configured to detect electromagnetic waves having traveled in the first direction. A method for adjusting electromagnetic wave detecting device includes: changing an image formation distance that is a distance between the first image forming part and at least a part of the reference plane; detecting electromagnetic waves traveling in the first direction by the first detector at a changed image formation distance; calculating a determination value based on detection results in the detecting; and adjusting a position of the first image forming part and the traveling part based on the image formation distance when the determination value becomes equal to or higher than the reference value.

### CROSS REFERENCE TO RELATED APPLICATION

This application claims the priority of Japanese Patent Application No. 2018-168938 (filed on Sep. 10, 2018), and the entire disclosure of this application is hereby incorporated for reference.

### TECHNICAL FIELD

The present disclosure relates to a method for adjusting an electromagnetic wave detecting device, an electromagnetic wave detecting device, and an information acquiring system.

### BACKGROUND

Conventionally, a configuration is known in which an image is formed on a mirror device, and an image reflected by the mirror device is further formed on an image sensor (see, for example, PTL 1).

### CITATION LIST

### Patent Literature

PTL 1: JP 3507865 A

### SUMMARY

A method for adjusting an electromagnetic wave detecting device according to an embodiment of the present disclosure is an adjustment method for an electromagnetic wave detecting device comprising a first image forming part, a traveling part, and a first detector. The first image forming part forms an image of electromagnetic waves incident from a detection object. The traveling part includes a reference plane and causes electromagnetic waves incident from the first image forming part to the reference plane to travel in a first direction. The first detector detects electromagnetic waves having traveled in the first direction. The method for adjustment includes changing an image formation distance between the first image forming part and at least a part of the reference plane. The method for adjustment includes detecting electromagnetic waves traveling in the first direction by the first detector at the changed image formation distance. The method for adjustment includes calculating a determination value based on detection results in the detecting. The method for adjustment includes adjusting a position of the first image forming part and the traveling part based on the image formation distance when the determination value becomes equal to or higher than a reference value.

An electromagnetic wave detecting device according to an embodiment of the present disclosure is an electromagnetic wave detecting device in which a position of the first image forming part and the traveling part is adjusted by the method for adjusting electromagnetic wave detecting device described above.

An information acquiring system according to an embodiment of the present disclosure comprises an electromagnetic wave detecting device and a control device. The electromagnetic wave detecting device is an electromagnetic wave detecting device in which a position of the first image forming part and the traveling part is adjusted by the method for adjusting electromagnetic wave detecting device described above. The control device acquires information for surroundings based on detection results of electromagnetic waves by the detector.

### BRIEF DESCRIPTION OF THE DRAWINGS

In the accompanying drawings:

FIG. 1 is a diagram showing a configuring example of an electromagnetic wave detecting device according to an embodiment.

FIG. 2 is a diagram showing an example of a relationship between an arrangement of pixels in a traveling part and an order of detection.

FIG. 3 is a block diagram showing a configuring example of an electromagnetic wave detecting device according to an embodiment.

FIG. 4 is a block diagram showing a configuring example of an information acquiring system according to an embodiment.

FIG. 5 is a diagram showing a configuring example of an electromagnetic wave detecting device according to another embodiment.

FIG. 6 is a diagram showing a configuring example in which a traveling part is located farther than a focal length of a first image forming part.

FIG. 7 is a diagram showing a configuring example in which a traveling part is located closer than a focal length of a first image forming part.

FIG. 8 is a diagram showing an example of a positional relationship between a second image forming part and a second detector.

FIG. 9 is a diagram showing an example of a chart used in a method for adjustment according to an embodiment.

FIG. 10 is a diagram showing an example of detection results of the chart in FIG. 9.

FIG. 11 is a diagram showing an example of detection results when an image formation distance is not within an adjustment range.

FIG. 12 is a diagram showing an example of detection results when an image formation distance is within an adjustment range.

FIG. 13 is a flowchart showing an example of a method for adjustment according to an embodiment.

### DETAILED DESCRIPTION

Hereinafter, embodiments according to the present disclosure will be described in detail with reference to the accompanying drawings. The drawings used in the following description are schematic. Dimensional ratios and the like on the drawings do not always correspond to actual ones.

A secondary imaging optical system using a digital micromirror device (DMD) or the like comprises a lens that forms images of incident electromagnetic waves on the DMD. When a position of the DMD with respect to the lens is adjusted, it is required to confirm whether a focus of the lens is aligned with a mirror arrangement plane of the DMD. The DMD itself does not function as a sensor for detecting electromagnetic waves. Therefore, it is required that the position of the DMD can be easily adjusted so that the focus of the lens is aligned with the mirror arrangement plane of the DMD.

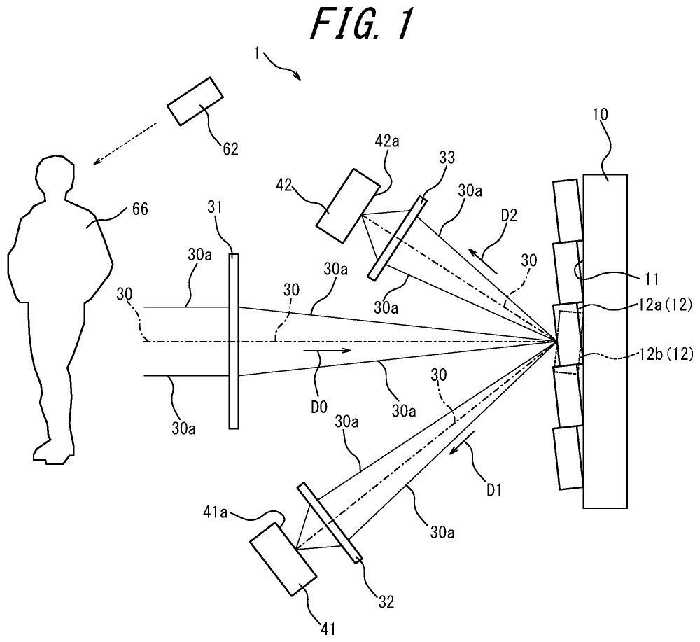

As shown in FIG. 1, an electromagnetic wave detecting device 1 according to an embodiment comprises a traveling part 10, a first image forming part 31, and a first detector 41. The electromagnetic wave detecting device 1 detects electromagnetic waves arriving from a detection object 66. The electromagnetic wave detecting device 1 controls a direction of electromagnetic waves by the traveling part 10. The electromagnetic wave detecting device 1 causes electromagnetic waves to travel along a traveling axis 30 shown in FIG. 1, for example. The traveling axis 30 corresponds to a main light ray at each angle of view when an electromagnetic wave is light. The electromagnetic waves traveling along the traveling axis 30 spreads out and travels in a range represented as a spreading range 30a. The electromagnetic wave detecting device 1 causes the electromagnetic waves to be incident on the first detector 41, and detects the electromagnetic waves by the first detector 41. The first detector 41 is also simply referred to as a detector.

The traveling part 10 comprises a reference plane 11 and a plurality of pixels 12 located along the reference plane 11. It can be said that the plurality of pixels 12 are arranged along the reference plane 11. The pixel 12 can change the traveling direction of the electromagnetic waves incident on the reference plane 11. The pixel 12 can transition to either a first state in which the electromagnetic waves incident on the reference plane 11 are caused to travel in a predetermined direction and a second state in which the electromagnetic waves incident on the reference plane 11 are caused to travel in a direction different from the predetermined direction. The traveling part 10 may cause each pixel 12 to transition to either the first state or the second state. The traveling part 10 may further comprise a processor that controls the transition of the state of each pixel 12. Each pixel 12 transitions to either the first state or the second state, and thereby causes the electromagnetic waves incident on the reference plane 11 to travel in a specific direction. A pixel 12 in transition to the first state is represented as pixel 12a in a solid line. A pixel 12 in transition to the second state is represented as pixel 12b in a dashed line.

The pixels 12 may comprise a reflection plane that reflects electromagnetic waves incident on the reference plane 11. The traveling part 10 may determine the direction in which electromagnetic waves incident on the reference plane 11 are reflected, by controlling the direction of the reflection plane of each pixel 12. The orientation of the reflection plane of each pixel 12 may be associated with the first state and the second state, respectively. That is, the traveling part 10 may determine the direction of reflecting electromagnetic waves by differentiating the orientation of the reflective surface of the pixel 12 when the pixel 12 is in transition to the first state and when it is in transition to the second state. The first state may be associated with a first reflective state that reflects the electromagnetic waves in the first direction. The second state may be associated with a second reflective state that reflects the electromagnetic waves in the second direction. The traveling part 10 may comprise a mirror device such as a DMD or a MEMS (Micro Electro Mechanical Systems) mirror. The pixel 12 may be a mirror element. The reference plane 11 may be an array plane of the mirror elements.

The pixel 12 of the traveling part 10 may comprise a shutter including a reflection plane that reflects electromagnetic waves. When the shutter is open, the electromagnetic waves shall be transmitted and travel in a predetermined direction. The state in which the shutter is open shall be associated with the first state. When the shutter is closed, the electromagnetic waves shall be reflected and travel in a direction different from the predetermined direction. The state in which the shutters are closed shall be associated with the second state. If the pixel 12 comprises a shutter, the traveling part 10 may comprise a MEMS shutter or the like having open/close controllable shutters arranged in an array along the reference plane 11.

The pixel 12 of the traveling part 10 may comprise a liquid crystal shutter. The liquid crystal shutter transitions to either a transmissive state in which electromagnetic waves are transmitted, or a reflective state in which electromagnetic waves are reflected, by controlling the orientation state of the liquid crystal. The transmissive state and the reflective state shall be associated with the first state and the second state, respectively.

The first image forming part 31 may form an image of incident electromagnetic waves at the reference plane 11. That is, the first image forming part 31 may be an optical member whose image forming point is located on the reference plane 11. The first image forming part 31 may be an optical member comprising at least one of a lens and a mirror. The first image forming part 31 may form an image on the reference plane 11 by refracting the electromagnetic waves having a spread in the range represented by the spread range 30a so as to narrow the spread range 30a.

The first detector 41 may comprise a first detecting plane 41a. The first detecting plane 41a is also referred to simply as a detecting plane. The first detector 41 may comprise at least one detecting element on the first detecting plane 41a. The first detector 41 may detect electromagnetic waves incident on the first detecting plane 41a. The first detector 41 may detect an intensity of the electromagnetic waves incident on the first detecting plane 41a. In this case, the first detector 41 does not have to detect the electromagnetic waves as an image.

The first detector 41 may comprise detecting elements arranged in an array along the first detecting plane 41a. The first detector 41 may comprise an imaging element, such as an image sensor or an imaging array, for example. In this case, the first detector 41 may capture images composed of electromagnetic waves incident on the first detecting plane 41a, and generate image information.

The first detector 41 may capture images composed of visible light. The first detector 41 is not limited to visible light, but may also capture images composed of infrared, ultraviolet, or other radio waves. The first detector 41 may comprise a distance measuring sensor. When the first detector 41 comprises the distance measuring sensor, the electromagnetic wave detecting device 1 may acquire distance information in the form of an image by the first detector 41. The first detector 41 may comprise a thermo sensor. When the first detector 41 comprises a thermo sensor, the electromagnetic wave detecting device 1 may acquire temperature information in the form of an image by the first detector 41.

The first detector 41 may include a single detecting element. The single detecting element may comprise an APD (Avalanche Photo-Diode), PD (Photo-Diode), SPAD (Single Photon Avalanche Diode) or the like. The single detecting element may comprise a millimeter wave sensor, a submillimeter wave sensor, a distance measuring image sensor or the like. The first detector 41 may comprise a detecting element array. The detecting element array may be an APD array, a PD array, an MPPC (Multi Photon Pixel Counter), a distance measuring imaging array, a distance measuring image sensor or the like.

The electromagnetic wave detecting device 1 may further comprise a second image forming part 32. The second image forming part 32 may form an image of electromagnetic waves controlled to be incident on the first detector 41 by the traveling part 10 at the first detecting plane 41a. That is, the second image forming part 32 may be an optical member whose image forming point is located at the first detecting plane 41a. The second image forming part 32 may be an optical member comprising at least one of a lens and a mirror.

The second image forming part 32 may form an image at the first detecting plane 41a by refracting the electromagnetic waves having a spread represented by the spread range 30a so as to narrow the spread range 30a. The first detector 41 may capture an image formed at the first detecting plane 41a by the second image forming part 32.

When the first detector 41 is composed of a single element, electromagnetic waves do not have to be formed an image at the first detecting plane 41a. In this case, the first detector 41 may not be provided near a secondary imaging position or vicinity of the secondary imaging position, which is an image forming position by the second image forming part 32. That is, the first detector 41 may be arranged at an arbitrary position so that electromagnetic waves emitted from the traveling part 10 can be incident on the first detecting plane 41a.

The electromagnetic wave detecting device 1 may further comprise a emitter 62. The emitter 62 emits electromagnetic waves toward a detection object 66 detected by the first detector 41. The first detector 41 may detect the detection object 66 by detecting reflected waves from the detection object 66. The emitter 62 may emit at least one of infrared rays, visible rays, ultraviolet rays, and radio waves. The emitter 62 may comprise, for example, an LED (Light Emitting Diode), LD (Laser Diode) and the like.

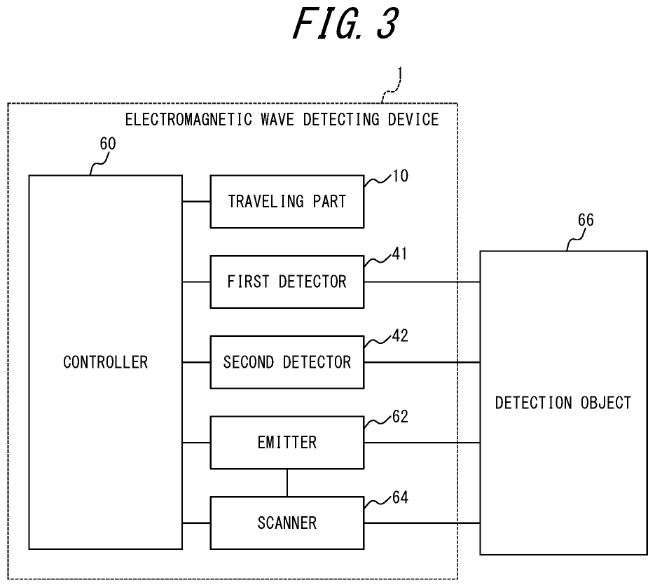

The electromagnetic wave detecting device 1 may map information to be detected from the detection object 66 by scanning the electromagnetic waves emitted from the emitter 62. The emitter 62 may scan electromagnetic waves by a phased scanning method capable of changing an emitting direction of the electromagnetic waves by controlling a phase of emitted electromagnetic waves. The electromagnetic wave detecting device 1 may further comprise a scanner 64 (see FIG. 3) that scans the electromagnetic waves emitted by the emitter 62. The scanner 64 comprises a scanning reflective plane that reflects the electromagnetic waves emitted by the emitter 62, and may scan the electromagnetic waves by changing the direction of the scanning reflective plane. The scanner 64 may comprise at least one of a MEMS mirror, a polygon mirror, and a galvanometer mirror.

When the electromagnetic wave detecting device 1 emits electromagnetic waves from the emitter 62 to the detection object 66, the first detector 41 may be an active sensor that detects the reflected waves of the electromagnetic waves emitted from the emitter 62 to the detection object 66. The first detector 41 may be a passive sensor that detects the electromagnetic waves arriving from the detection object 66 regardless of whether the electromagnetic waves are emitted from the emitter 62.

By the traveling part 10 controlling the traveling direction of the electromagnetic waves, the electromagnetic waves can travel along the traveling axis 30 illustrated in FIG. 1.

After passing through the first image forming part 31, the electromagnetic waves incident on the first image forming part 31 travels in the incident direction represented by D0 and is incident on the reference plane 11 of the traveling part 10. The traveling part 10 changes the traveling direction of the electromagnetic waves incident on the reference plane 11 by controlling the state of the pixel 12 located at the incident point of the electromagnetic waves. The traveling part 10 causes the electromagnetic waves to travel in the first direction represented by D1 by causing the pixel 12 located at the incident point of the electromagnetic waves to transition to the first state. The traveling part 10 causes the electromagnetic waves to travel in the second direction represented by D2 by causing the pixel 12 located at the incident point of the electromagnetic wave to transition to the second state.

The electromagnetic waves traveling in the first direction is incident on the first detecting plane 41a. That is, the pixel 12 in transition to the first state emits electromagnetic waves toward the first detecting plane 41a.

When the electromagnetic wave detecting device 1 comprises the second image forming part 32, the electromagnetic waves are emitted from the pixel 12 and then pass through the second image forming part 32 and then are incident on the first detecting plane 41a. The main plane of the second image forming part 32 may be parallel to the first detecting plane 41a.

As described above, the electromagnetic wave detecting device 1 can control whether the electromagnetic waves incident from the third plane 23 is allowed to enter the first detecting plane 41a by transitioning the pixels 12 of the traveling part 10 to either the first state or the second state.

The electromagnetic wave detecting device 1 may further comprise a second detector 42. The second detector 42 comprise a second detecting plane 42a. The second detecting plane 42a is also simply referred to as a detecting plane. The second detector 42 may be configured to be the same as or similar to the first detector 41. The second detector 42 may comprise the same type of sensor as that in the first detector 41 or a different type of sensor from that in the first detector 41. The second detector 42 may detect the same kind of electromagnetic waves as those that the first detector 41 detects or a different kind of electromagnetic waves from those that the first detector 41 detects. The second detector 42 may be positioned so that it can detect electromagnetic waves emitted in the second direction from the pixel 12 that is in transition to the second state. That is, the second detector 42 may be positioned so that the electromagnetic waves traveling in the second direction from the pixel 12 are incident on the second detecting plane 42a.

The electromagnetic wave detecting device 1 may further comprise a third image forming part 33. The third image forming part 33 may form an image of electromagnetic waves, controlled to be incident on the second detector 42 by the traveling part 10, on the second detecting plane 42a. That is, the third image forming part 33 may be an optical member whose imaging point is located on the second detecting plane 42a. The third image forming part 33 may be an optical member comprising at least one of a lens and a mirror. The third image forming part 33 may form an image on the second detecting plane 42a by refracting electromagnetic waves having a spread represented by the spread range 30a so as to narrow the spread range 30a. The second detector 42 may capture an image formed on the second detecting plane 42a by the third image forming part 33.

The emitter 62 may comprise a first emitter and a second emitter. The first detector 41 may detect the reflected waves of the electromagnetic waves emitted from the first emitter. The second detector 42 may detect the reflected waves of the electromagnetic waves emitted from the second emitter.

Even if the first detector 41 and the second detector 42 do not detect electromagnetic waves as an image, the electromagnetic wave detecting device 1 can acquire an image composed of electromagnetic waves as image information by causing the pixels 12 of the traveling part 10 to transition to the first state one by one. For example, the electromagnetic wave detecting device 1 can detect electromagnetic waves in one or two dimensions by synchronizing the state of the pixel 12 with the detecting results of the first detector 41 or the second detector 42.

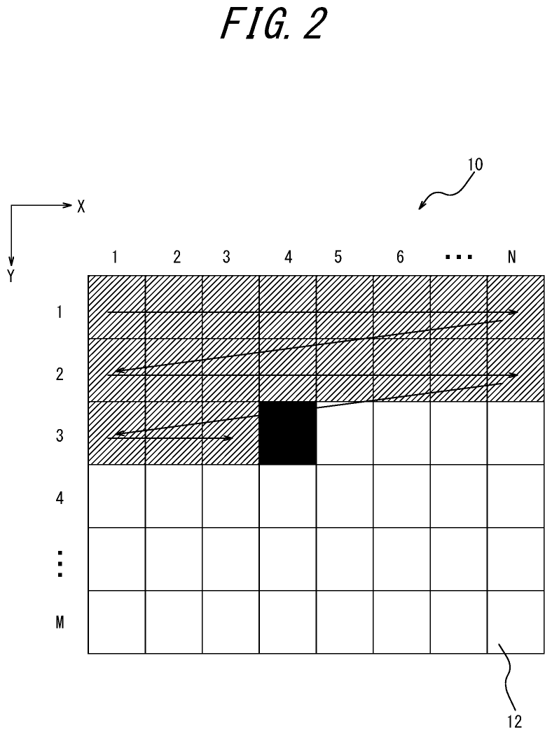

As illustrated in FIG. 2, it is assumed that the pixels 12 of the traveling part 10 are arranged in two dimensions. In the example of FIG. 2, N pieces of pixels 12 are arranged in the X direction and M pieces of pixels 12 are arranged in the Y direction. That is, the pixels 12 are arranged in a two-dimensional array of N by M pixels. It is assumed that each pixel 12 is identified by the coordinates attached in the X and Y directions, respectively. For example, the pixel 12 located in the upper left corner is represented as (1, 1). The pixel 12 located in the lower right corner is represented as (N, M).

For example, the electromagnetic wave detecting device 1 transitions only (1, 1) of the pixel 12 to the first state when all pixels 12 are in transition to the second state as the initial state. The electromagnetic wave detecting device 1 associates the detection results of the electromagnetic waves by the first detector 41 with (1, 1) of the pixel 12 while only (1, 1) of the pixels 12 are in transition to the first state. That is, the electromagnetic wave detecting device 1 associates the detection results of the electromagnetic waves in the first detector 41 with the pixel 12 that is in transition to the first state.

Subsequently, the electromagnetic wave detecting device 1 causes (1,1) of the pixel 12 to transition to the second state, and only (2,1) of the pixel 12 to transition to the first state. In this way, the electromagnetic wave detecting device 1 sequentially causes the pixel 12 arranged in two dimensions to transition to the first state one by one. The electromagnetic wave detecting device 1 may cause each pixel 12 to transition to the first state according to an order of the raster scan, and associate each pixel 12 with the detection results of the electromagnetic waves by the first detector 41. The order in which each pixel 12 transitions to the first state is not limited to the order of raster scan, and may be various other orders. In the example of FIG. 2, (4, 3) of the pixels 12 filled with black is in transition to the first state. The pixel 12 represented by the hatching of the diagonal line has been already associated with the detection results by the first detector 41.

The electromagnetic wave detecting device 1 may collectively cause a predetermined number of adjacent pixels 12 to transition to the first state. A predetermined number of adjacent pixels 12 are also referred to as a change unit. The predetermined number may be one, or two or more. For each change unit, the electromagnetic wave detecting device 1 may sequentially cause the pixels 12 included in the change unit to transition from the second state to the first state. The electromagnetic wave detecting device 1 associates the result of detecting the electromagnetic waves by the first detector 41 with the change unit while the pixel 12 included in the change unit is in transition to the first state.

As shown in FIG. 3, the electromagnetic wave detecting device 1 may further comprise a controller 60. The controller 60 can control the traveling direction of the electromagnetic waves by controlling the traveling part 10. The controller 60 may acquire the detection results of the electromagnetic waves from the first detector 41 and the second detector 42. The controller 60 may acquire image information for an image composed of electromagnetic waves from the first detector 41 and the second detector 42. The controller 60 acquires image information for an image composed of electromagnetic waves by synchronizing the control of each pixel 12 of the traveling part 10 with the detection results acquired from the first detector 41 or the second detector 42. The controller 60 may control emitting or scanning electromagnetic waves by controlling the emitter 62 or the scanner 64. The controller 60 may acquire image information for an image composed of electromagnetic waves based on the control for emitting or scanning electromagnetic waves and the detection results acquired from the first detector 41.

When the first detector 41 is a distance measuring sensor, the controller 60 may acquire distance information. The controller 60 may acquire the distance information for the detection object 66 by the ToF (Time of Flight) method based on the detection results acquired from the first detector 41. As the ToF method, the controller 60 may execute the Direct ToF method that directly measures the time from the emission of the electromagnetic wave to the detection of the reflected wave. As the ToF method, the controller 60 may execute the Flash ToF method, in which it periodically emits electromagnetic waves and indirectly measures the time from emitting the electromagnetic waves to detecting the reflected waves based on the phase of the emitted electromagnetic waves and the phase of the reflected waves. As the ToF method, the controller 60 may execute other methods, such as Phased ToF. The controller 60 may execute the ToF method by causing the emitter 62 to emit electromagnetic waves.

The controller 60 may comprise, for example, a time measurement LSI (Large Scale Integrated circuit). The controller 60 may calculate the time elapsed from causing the emitter 62 to emit electromagnetic waves toward the detection object 66 to the first detector 41 detecting reflected waves from the detection object 66, as the response time. The controller 60 may calculate the distance to the detection object 66 based on the response time. When causing the emitter 62 or the scanner 64 to scan the electromagnetic waves, the controller 60 may generate distance information in the form of an image by synchronizing the emitting direction of the electromagnetic waves with the detection results acquired from the first detector 41.

When the first detector 41 is a thermo sensor, the controller 60 may acquire temperature information. The controller 60 may acquire information for the surroundings of the electromagnetic wave detecting device 1 based on the detection results of the electromagnetic waves acquired from the first detector 41. The information for the surroundings may include at least one of image information, distance information, and temperature information.

The controller 60 comprises one or more processors and memories. The processor may include at least one of a general-purpose processor that loads a specific program and executes a specific function, and a dedicated processor that is specialized for a specific process. The dedicated processor may include an application specific integrated circuit (ASIC). The processor may include a programmable logic device (PLD). The PLD may include a field programmable gate array (FPGA). The controller 60 may include at least one of a SoC (System-on-a-Chip) and a SiP (System-in-a-Package) in which one or a plurality of processors cooperate together.

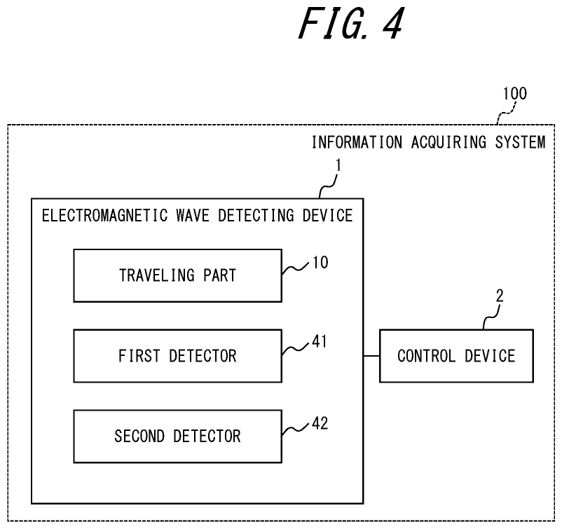

As shown in FIG. 4, the information acquisition system 100 according to an embodiment comprises an electromagnetic wave detecting device 1 and a control device 2. The control device 2 may acquire information for the surroundings of the electromagnetic wave detecting device 1 based on the detection results of the electromagnetic waves by the first detector 41. The information for the surroundings may include at least one of image information, distance information, and temperature information.

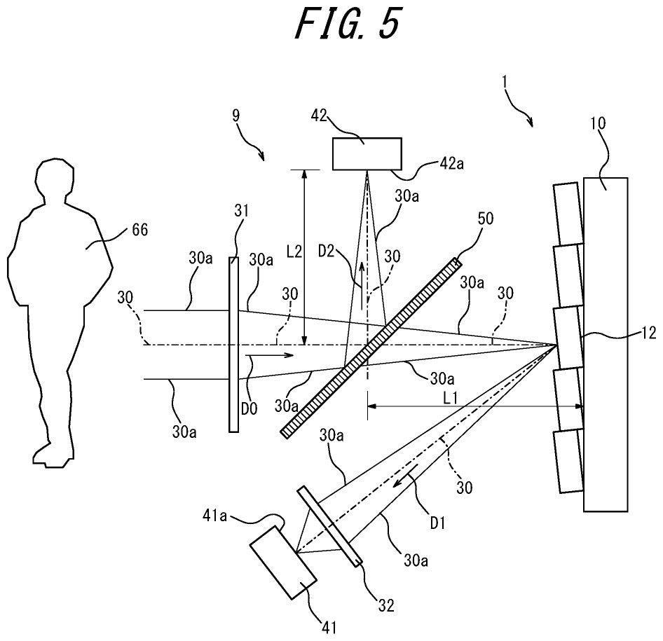

As shown in FIG. 5, the electromagnetic wave detecting device 1 according to another embodiment may further comprise a separator 50. The separator 50 is positioned so that electromagnetic waves traveling in the incident direction represented by D0 is incident. The separator 50 separates the incident electromagnetic waves. One of the separated electromagnetic waves: travels through the separator 50; travels as it is; is incident on the traveling part 10; changes the traveling direction to the first direction that is represented by D1 by the pixel 12 that is in transition to the first state; and is incident on the first detector 41. The other one of the separated electromagnetic waves: is reflected by the separator 50; travels in the second direction represented by D2; and is incident on the second detector 42.

The separator 50 may reflect electromagnetic waves at a predetermined reflectance. If the predetermined reflectance is constant regardless of the wavelength of the electromagnetic waves, the image formed on the second detecting plane 42a of the second detector 42 may be an image in which the intensity of the electromagnetic waves as a whole image is only changed by a predetermined ratio, as compared with the image formed on the reference plane 11 of the traveling part 10.

The separator 50 may cause the electromagnetic waves to reflect at a reflectance determined based on the wavelength of the electromagnetic waves, to travel in the second direction, and to be incident on the second detecting plane 42a of the second detector 42. For example, the separator 50 may reflect electromagnetic waves having a wavelength within the predetermined range at a reflectance of a predetermined value or more, and may reflect electromagnetic waves having a wavelength out of the predetermined range at a reflectance of less than the predetermined value. In this way, the electromagnetic waves having a wavelength within the predetermined range are easily incident on the second detecting plane 42a of the second detector 42. On the other hand, the electromagnetic waves having a wavelength out of the predetermined range transmit through the separator 50 and are easily incident on the traveling part 10. As a result, electromagnetic waves can be separated based on their wavelengths. In other words, the separator 50 can separate electromagnetic waves based on their wavelengths.

The predetermined range may be a value greater than or equal to the predetermined wavelength, or a range identified as a value above the predetermined wavelength. The predetermined range may be a value less than or equal to the predetermined wavelength, or a range identified as a value below the predetermined wavelength. The predetermined range may be a range identified as a value greater than or equal to the first predetermined wavelength and less than or equal to the second predetermined wavelength. The predetermined range may be a range identified as a value less than or equal to the first predetermined wavelength or greater than or equal to the second predetermined wavelength.

By the separator 50 separating electromagnetic waves based on the wavelength, an image with matching coordinates in the image that is composed of electromagnetic waves having different wavelengths is formed on each of the second detecting surface 42a of the second detector 42 and the reference plane 11 of the traveling part 10. If the coordinates of the images formed on the second detecting plane 42a and those on the reference plane 11 match, the image information detected by the first detector 41, or the distance information or temperature information in the form of an image, can be easily superimposed on the image information detected by the second detector 42. Further, by the separator 50 separating the electromagnetic waves based on the wavelength, the first detector 41 and the second detector 42 can be configured as sensors for detecting the electromagnetic waves with specific wavelengths, respectively.

The separator 50 may comprise at least one of a visible light reflective coating, a half mirror, a beam splitter, a dichroic mirror, a cold mirror, a hot mirror, a metaplane, and a deflecting element.

In FIG. 5, the distance from the separator 50 to the reference plane 11 of the traveling part 10 is represented as L1. The distance from the separator 50 to the second detecting plane 42a is represented as L2. When L1 is equal to L2, the optical path length from the first image forming part 31 to the reference plane 11 is equal to the optical path length from the first image forming part 31 to the second detecting plane 42a.

When a single-wavelength electromagnetic waves are incident on the first image forming part 31, the imaging distance of the electromagnetic wave incident on the reference surface 11 is equal to the imaging distance of the electromagnetic wave incident on the second detection surface 42a. That is, the position where the electromagnetic waves form an image can be aligned with both the reference plane 11 and the second detecting plane 42a.

When electromagnetic waves having a plurality of wavelengths are incident on the first image forming part 31 and the separator 50 separates the electromagnetic waves based on their wavelengths, the imaging distance of the electromagnetic waves incident on the reference plane 11 is differ from the imaging distance of the electromagnetic waves incident on the second detection surface 42a. If L1 is equal to L2, the position where the electromagnetic wave forms an image will not align with at least one of the reference plane 11 and the second detecting plane 42a.

The position of the second detector 42 can be easily adjusted based on the detection results of the electromagnetic waves by the second detector 42. On the other hand, the position of the traveling part 10, which causes the electromagnetic waves to travel toward the first detector 41, is harder to adjust than that of the second detector because the traveling part 10 itself does not detect the electromagnetic waves.

If L1 is made equal to L2, the position of the traveling part 10 can be easily adjusted by aligned with the position of the second detector 42. If L1 differs from L2, the position of the traveling part 10 needs to be adjusted in some other way.

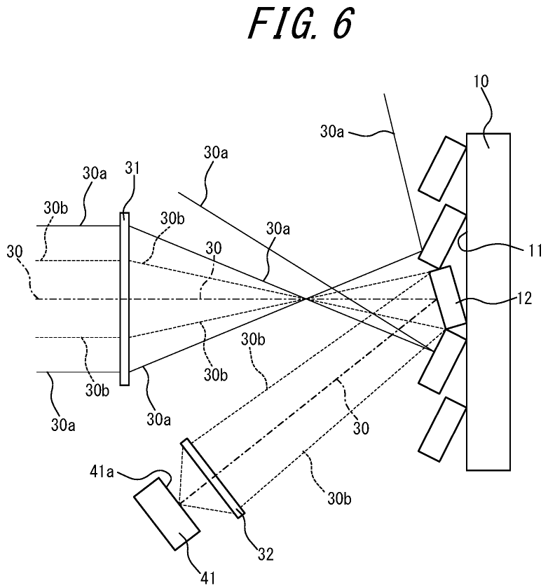

As shown in FIG. 6, it is assumed that the focal point of the first image forming part 31 is located between the first image forming part 31 and the reference plane 11 of the traveling part 10. The electromagnetic waves traveling along the traveling axis 30 pass through the first image forming part 31, and then converges toward the focal point. When the focal point is located between the first image forming part 31 and the reference plane 11, the electromagnetic wave travels to the reference plane 11 while spreading after passing through the focal point. Among the electromagnetic waves, the electromagnetic waves having the spread of the range represented by the spread range 30b reaches within the range of one pixel 12. On the other hand, among the electromagnetic waves, the electromagnetic waves having the spread of the range represented by the spread range 30a reaches across the plurality of pixels 12.

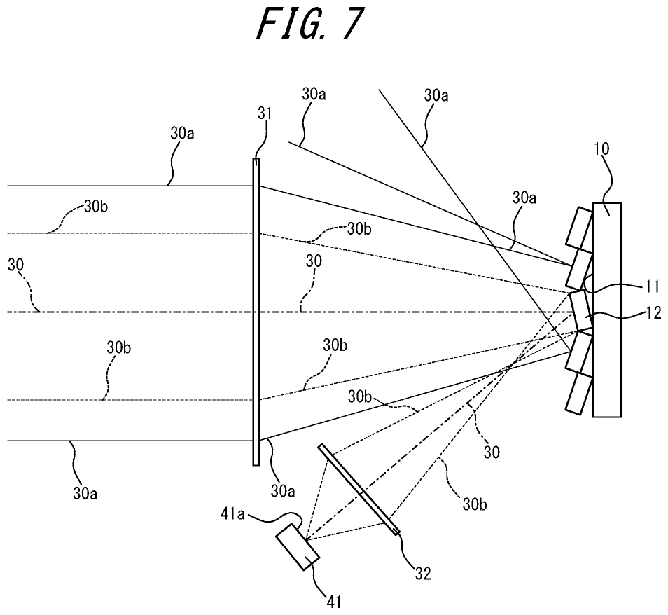

As shown in FIG. 7, it is assumed that the focal point of the first image forming part 31 is located on the far side of the reference plane 11 of the traveling part 10 as viewed from the first image forming part 31. In this case, the electromagnetic waves traveling along the traveling axis 30 travels toward the reference plane 11 while converging toward the focal point after passing through the first image forming part 31, but the electromagnetic waves reach the reference plane 11 before focusing. Among the electromagnetic waves, the electromagnetic waves having the spread of the range represented by the spread range 30b reach within the range of one pixel 12. On the other hand, among the electromagnetic waves, the electromagnetic waves having the spread of the range represented by the spread range 30a reach across a plurality of pixels 12.

It is assumed that each pixel 12 is in transition to the first state one by one when the electromagnetic waves travel as illustrated in FIGS. 6 and 7. When the pixel 12 that the traveling axis 30 reaches has transitioned to the first state, the electromagnetic waves having the spread of the range represented by the spread range 30b travels to the first detector 41. A part of the electromagnetic waves having the spread of the range represented by the spread range 30a travels to the first detector 41. The other part of the electromagnetic waves do not travel to the first detector 41. In this case, the intensity of the electromagnetic waves incident on the first detector 41 is less than the intensity of the electromagnetic waves incident on the first image forming part 31.

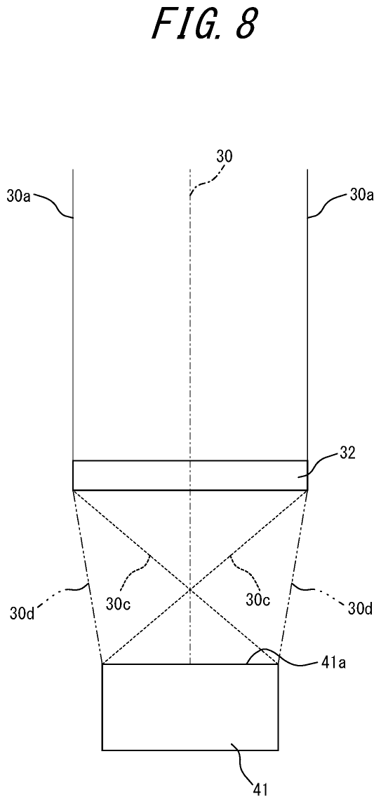

As shown in FIG. 8, an electromagnetic waves traveling along the traveling axis 30 toward the first detector 41 may be formed an image on the first detecting plane 41a by the second image forming part 32. The focal point of the second image forming part 32 may be located on the first detecting plane 41a. When the focal point of the second image forming part 32 is located between the second image forming part 32 and the first detecting plane 41a, the electromagnetic waves have a range of spread represented by the spread range 30c. When the focal point of the second image forming part 32 is located on the far side of the first detecting plane 41a as viewed from the second image forming part 32, the electromagnetic waves have a spread in the range represented by the spread range 30d.

If the spread of electromagnetic waves reaching the first detecting plane 41a is within the range of the first detecting plane 41a, most of the electromagnetic waves traveling from the traveling part 10 to the first detector 41 can reach the first detecting plane 41a. In this case, the intensity of the electromagnetic waves detected at the first detector 41 can be equal to the intensity of the electromagnetic waves traveling from the traveling part 10 toward the first detector 41. On the other hand, when the electromagnetic waves reaching the first detecting plane 41a spread outside the range of the first detecting plane 41a, a part of the electromagnetic waves traveling from the traveling part 10 toward the first detector 41 do not reach the first detecting plane 41a. In this case, the intensity of the electromagnetic waves detected at the first detector 41 will be less than the intensity of the electromagnetic waves traveling from the traveling part 10 toward the first detector 41. In other words, even if the focal point of the second image forming part 32 is not located on the first detecting plane 41a, the positions of the second image forming part 32 and the first detector 41 may be determined so that the spread of electromagnetic waves converges within the range of the first detecting plane 41a.

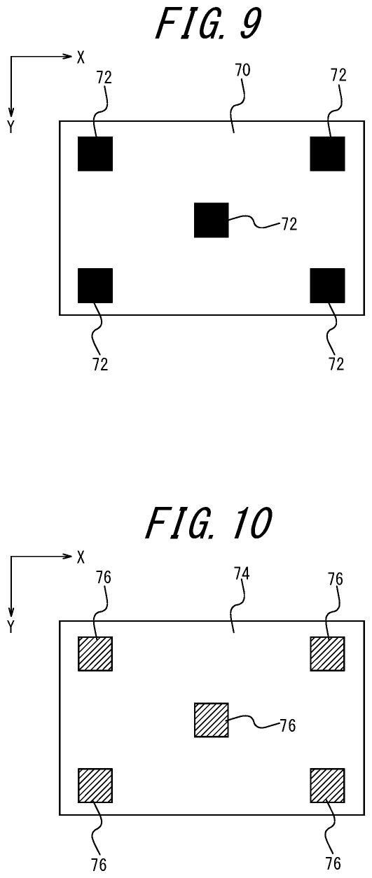

The electromagnetic wave detecting device 1 may detect the chart 70 illustrated in FIG. 9 as the detection object 66. The chart 70 comprises a determination pattern 72 represented by a black rectangle. The determination pattern 72 may be configured to produce a predetermined contrast in the image based on the chart 70. The reflectance of the electromagnetic waves in the determination pattern 72 is assumed to be lower than that of the surroundings, but the reflectance may be higher than that of the surroundings. The portion of the chart 70 other than the determination pattern 72 is represented by white and has a higher reflectance than the determination pattern 72. The chart 70 is not limited to this example and may comprise various patterns. The determination pattern 72 is also referred to as a specific pattern.

The electromagnetic wave detecting device 1 generates the detected image 74 illustrated in FIG. 10 by detecting the chart 70 in FIG. 9. The detected image 74 includes a detection pattern 76. The detection pattern 76 is generated based on the determination pattern 72 of the chart 70.

When the electromagnetic waves emitted from the detection object 66 have one-dimensional or two-dimensional spread, the electromagnetic waves can be divided into linear or planar regions. It is assumed that these regions are divided so that they can be associated with each pixel 12 of the traveling part 10. It is assumed that the pixel 12 includes a first pixel that receives electromagnetic waves emitted from the determination pattern 72 when the focal point of the first image forming part 31 is located on the reference plane 11 of the traveling part 10 as illustrated in FIG. 1. In other words, the electromagnetic waves traveling toward the first pixel is emitted from the determination pattern 72. It is assumed that the pixel 12 includes a second pixel that receives electromagnetic waves emitted from a region not included in the determination pattern 72 when the focal point of the first image forming part 31 is located on the reference plane 11 of the traveling part 10 as illustrated in FIG. 1. In other words, the electromagnetic waves traveling toward the second pixel are emitted from a region not included in the determination pattern 72. It is assumed that the first pixel and the second pixel are adjacent to each other. It is assumed that the intensity of the electromagnetic waves detected by the first pixel is represented by I1 when the focal point of the first image forming part 31 is located on the reference plane 11 of the traveling part 10. It is assumed that the intensity of the electromagnetic waves detected by the second pixel is represented by I2 when the focal point of the first image forming part 31 is located on the reference plane 11 of the traveling part 10. Because the reflectance of the electromagnetic waves in the determination pattern 72 is lower than that of the surroundings, I1 becomes lower than I2.

When the focal point of the first image forming part 31 is located on the reference plane 11 of the traveling part 10, the electromagnetic waves traveling toward the first pixel converge on the first pixel and form an image on the first pixel. If the focal point of the first image forming part 31 is not located on the reference plane 11 of the traveling part 10, the electromagnetic waves traveling toward the first pixel reaches the first pixel with a predetermined spread. Among the electromagnetic waves having a predetermined spread, the electromagnetic waves spreading in the range represented by the spread range 30b reaches only within the range of the first pixel. The electromagnetic waves spreading in the range represented by the spreading range 30a reaches outside the range of the first pixel, and also reaches the second pixel adjacent to the first pixel.

On the other hand, the electromagnetic waves traveling toward the second pixel reaches the second pixel in a state having a predetermined spread like as well as the electromagnetic waves traveling toward the first pixel. A part of the electromagnetic waves traveling toward the second pixel reaches not only the second pixel but also the first pixel.

The position of the traveling part 10 with respect to the first image forming part 31 is required to be adjusted so that the electromagnetic waves traveling toward the first pixel reaches only the first pixel and the electromagnetic waves traveling toward the second pixel reaches only the second pixel. When the positional relationship between the first image forming part 31 and the traveling part 10 is adjusted as described above, the distance from the first image forming part 31 to the reference plane 11 or each pixel 12 is within a predetermined range. The predetermined range in this case is also referred to as an adjustment range.

When the main plane of the first image forming part 31 and the reference plane 11 of the traveling part 10 are parallel, the electromagnetic waves passing through the first image forming 31 can form an image on each pixel 12 on the reference plane 11. When the reference plane 11 is tilted with respect to the main plane of the first image forming part 31, the electromagnetic waves passing through the first image forming part 31 forms an image on the reference plane 11 for some pixels 12, but forms an image at positions not on the reference plane 11 for other pixels 12. That is, the electromagnetic waves form an image on the side closer to or far from the first image forming part 31 when viewed from the reference plane 11.

The electromagnetic wave detecting device 1 adjusts the position of the traveling part 10 with respect to the first image forming part 31 by changing the distance between the first image forming part 31 and at least a part of the reference plane 11 of the traveling part 10. The distance between the first image forming part 31 and at least a part of the reference plane 11 of the traveling part 10 is also referred to as an image forming distance.

When the electromagnetic wave traveling toward the first pixel reaches only the first pixel, the intensity of the electromagnetic waves, traveling from the first pixel to the first detector 41 and being detected, can be I1. When the electromagnetic waves traveling toward the second pixel reaches only the second pixel, the intensity of the electromagnetic waves, traveling from the second pixel to the first detector 41 and being detected, can be I2.

When electromagnetic waves traveling toward the first pixel and toward the second pixel arrive across the first and the second pixels, respectively, the intensity of the electromagnetic waves incident on the first pixel becomes higher than I1 and the intensity of the electromagnetic waves incident on the second pixel becomes lower than I2. In this case, the intensity of the electromagnetic waves that travels from the first pixel to the first detector 41 and is detected by the first detector 41 is higher than I1. The intensity of the electromagnetic waves that travels from the second pixel to the first detector 41 and is detected by the first detector 41 is lower than I2. As a result, the difference between the intensity of the electromagnetic waves detected at the first pixel and the intensity of the electromagnetic waves detected at the second pixel becomes lower. In other words, the contrast between the detection pattern 76 included in the detected image 74 and the surrounding region becomes lower. The controller 60 may acquire the detected image 74 as detection results.

The controller 60 may associate each pixel 12 with the result of detecting electromagnetic waves by the first detector 41 while sequentially causing each pixel 12 to transition to the first state. On the other hand, the controller 60 may cause only one pixel 12 to transition to the first state, and associate the result of detecting the electromagnetic waves by the first detector 41 with the pixel 12. For example, the controller 60 may cause only the first pixel to transition to the first state and associate the result of detecting the electromagnetic waves traveling from the first pixel toward the first detector 41 with the first pixel.

When the image forming distance is out of the adjustment range, a part of the electromagnetic waves traveling toward the first pixel is not incident on the first pixel, and a part of the electromagnetic waves traveling toward the second pixel is incident on the first pixel. In this case, the first detector 41 detects electromagnetic waves in which electromagnetic waves traveling toward the first pixel and electromagnetic waves traveling toward the second pixel are mixed. As described above, the electromagnetic waves traveling toward the first pixel is emitted from the determination pattern 72 in FIG. 9. The electromagnetic waves traveling toward the second pixel is emitted from a region other than the determination pattern 72 in FIG. 9. In this case, the intensity of the electromagnetic waves detected by the first detector 41 is higher than I1 and lower than I2. The controller 60 may acquire the intensity of the electromagnetic waves from the first pixel detected by the first detector 41 as detection results.

The controller 60 may determine whether the distance from the first image forming part 31 to the reference plane 11 or each pixel 12 is within the adjustment range based on the detection results. When the controller 60 acquires the intensity of electromagnetic waves from one pixel 12 such as the first pixel, as detection results, the controller 60 may determine whether the distance from the first image forming part 31 to the pixel 12 is within the adjustment range based on the intensity of the detected electromagnetic waves. The controller 60 may acquire the intensity of the electromagnetic waves emitted from the determination pattern 72 in FIG. 9 as detection results. And if the intensity is lower than a predetermined value, the controller 60 may determine that the distance between the pixel 12 corresponding to the region where the electromagnetic wave was emitted and the first image forming part 31 is within the adjustment range. The controller 60 may acquire the intensity of the electromagnetic waves emitted from the region other than the determination pattern 72 in FIG. 9 as detection results. And if the intensity is higher than a predetermined value, the controller 60 may determine that the distance between the pixel 12 corresponding to the region where the electromagnetic waves were emitted and the first image forming part 31 is within the adjustment range. The controller 60 may determine whether the distance between the first image forming part 31 and each pixel 12 is within the adjustment range. The controller 60 may adjust the inclination of the reference plane 11 of the traveling part 10 with respect to the main plane of the first image forming part 31 based on the determination result for the distance between the first image forming part 31 and each pixel 12.

When acquiring the detected image 74 as detection results, the controller 60 may determine whether the distance between the first image forming part 31 and the reference plane 11 is within the adjustment range based on the contrast for at least some regions of the detected image 74. The controller 60 may determine that the distance between the first image forming part 31 and the reference plane 11 is within the adjustment range when the contrast for at least some regions of the detected image 74 is greater than the predetermined value. The controller 60 may determine that the distance between the first image forming part 31 and the reference plane 11 is within the adjustment range when the contrast for the entire detected image 74 is greater than a predetermined value. The controller 60 may determine that the distance between the pixels 12 corresponding to some regions of the detected image 74 and the first image forming part 31 is within the adjustment range when the contrast for some regions of the detected image 74 is greater than the predetermined value. Based on the contrast for the plurality of regions of the detected image 74, the controller 60 may determine whether the distance between the pixel 12 corresponding to those regions and the first image forming part 31 is within the adjustment range. The controller 60 may adjust the inclination of the reference plane 11 of the traveling part 10 with respect to the main plane of the first image forming part 31 based on the determination result for each region.

The controller 60 may calculate a determination value based on the detection results in order to determine whether the distance between the first image forming part 31 and the reference plane 11 is within the adjustment range based on the detection results. When the determination value is equal to or greater than the reference value, the controller 60 may determine that the distance between the first image forming part 31 and the reference plane 11 is within the adjustment range.

When acquiring the intensity of the electromagnetic waves emitted from the determination pattern 72 in FIG. 9 as the detection results, the controller 60 may calculate the determination value so that the lower the intensity of the electromagnetic waves, the higher the determination value. When acquiring the intensity of the electromagnetic waves emitted from the regions other than the determination pattern 72 in FIG. 9 as the detection results, the controller 60 may calculate the determination value so that the higher the intensity of the electromagnetic waves, the higher the determination value. The controller 60 may appropriately set the reference value so that the determination value becomes equal to or greater than the reference value when the distance between the pixel 12 corresponding to the detection results and the first image forming part 31 is within the adjustment range.

When acquiring the detected image 74 as the detection results, the controller 60 may calculate the contrast in at least a part of the detected image 74 as a determination value. The determination value is not limited to these examples, and may be set in various modes. When calculating the overall contrast of the detected image 74 as the determination value, the controller 60 may set the reference value appropriately so that the determination value becomes greater than or equal to the reference value when the distance between the first image forming part 31 and the reference plane 11 is within the adjustment range.

When the first detector 41 is a distance measuring sensor, the controller 60 can calculate the distance to the part where the electromagnetic waves were emitted based on the detection results of the electromagnetic waves by the first detector 41. When the distance is calculated using the ToF method, the controller 60 calculates the distance corresponding to the detected electromagnetic waves based on the time when the electromagnetic waves were detected. The controller 60 calculates the distance to the part where the electromagnetic waves were emitted based on the time when the electromagnetic waves having an intensity equal to or higher than a predetermined value is detected.

It is assumed that the chart 70 includes regions having different distances from the electromagnetic wave detecting device 1. For example, the chart 70 illustrated in FIG. 9 may be configured so that the distance to the determination pattern 72 represented in black and the distance to the region other than the determination pattern 72 are different. The determination pattern 72 may be an opening. When the determination pattern 72 is an opening, the controller 60 can calculate the distance to the background located farther than the chart 70 including the determination pattern 72 as the distance to the determination pattern 72.

When electromagnetic waves emitted from a plurality of objects located at different distances are incident on the first detector 41, the controller 60 can calculate the respective distances. For example, it is assumed that electromagnetic waves from a region located at a first distance from the electromagnetic wave detecting device 1 and electromagnetic waves from a region located at a second distance from the electromagnetic wave detecting device 1 are incident on one pixel 12. In this case, when the intensity of the electromagnetic waves corresponding to the first distance is higher than or equal to a predetermined value, the controller 60 determines that the object emitting the electromagnetic waves is located at the first distance, and calculates the first distance as the distance to the object. When the intensity of the electromagnetic waves corresponding to the second distance is higher than or equal to a predetermined value, the controller 60 determines that the object emitting the electromagnetic waves is located at the second distance, and calculates the second distance as the distance to the object. The first distance is the distance to the determination pattern 72. The second distance is the distance to the region other than the determination pattern 72. Further, as described above, the pixel 12 that receives the electromagnetic waves emitted from the determination pattern 72 is also referred to as the first pixel. The pixel 12 that receives the electromagnetic waves emitted from the region not included in the determination pattern 72 is also referred to as the second pixel.

When the distance between the first image forming part 31 and the pixel 12 is within the adjustment range, only the electromagnetic waves emitted from the determination pattern 72 is incident on the first pixel. In this case, the controller 60 calculates the first distance as the distance to the object based on the electromagnetic waves from the first pixel. When the distance between the first image forming part 31 and the pixel 12 is not within the adjustment range, not only the electromagnetic waves emitted from the determination pattern 72 but also the electromagnetic waves emitted from the region not included in the determination pattern 72 can be incident on the first pixel. In this case, the controller 60 can calculate the first distance and the second distance as the distance to the object based on the electromagnetic waves from the first pixel.

The controller 60 may consider the calculated distance as the detection results. The controller 60 may calculate the determination value based on the calculated distance. The determination value may be a number of calculated distances. When the calculated number of distances is 1, the controller 60 may determine that the distance between the first image forming part 31 and the pixels 12 is within the adjustment range. The determination value may be the calculated distance itself. In this case, the controller 60 may acquire the distance to be calculated in advance and set the reference value based on the value. The determination value is not limited to these examples, and may be set in various modes.

The controller 60 may map the distance to each region of the detection object 66 in one dimension or two dimensions. The controller 60 may determine whether the distance between the first image forming part 31 and the reference plane 11 or the pixel 12 is within the adjustment range based on the comparison between the actual distance to each region of the detection object 66 and the map of the distance information.

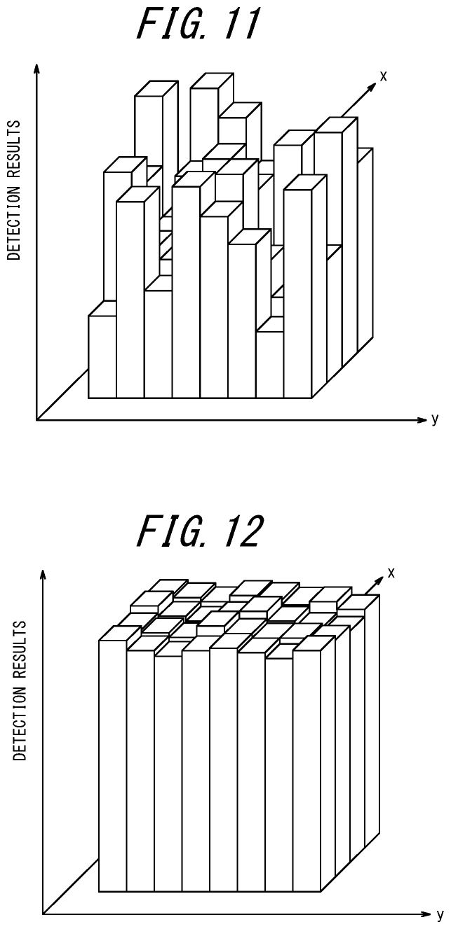

The controller 60 may detect the distance to each region of the chart 70 (that is, a simple plane) having no determination pattern 72, and map the distance information. When the distance between the first image forming part 31 and the pixel 12 is not within the adjustment range, a number of the electromagnetic waves incident on one pixel 12 can be reduced. As a result, the intensity of the electromagnetic waves incident on the first detector 41 may decrease. When the intensity of the electromagnetic waves incident on the first detector 41 decreases, the detection results of the first detector 41 may contain a lot of noise. The controller 60 may calculate an incorrect distance based on the detection results that contains a lot of noise. The incorrectly calculated distance can be a random value. The map of distances acquired in this way can have a large distribution as shown in FIG. 11. When the distance between the first image forming part 31 and the pixel 12 is not within the adjustment range, the controller 60 acquires distance data having a large distribution even though the distance to each region of a simple plane is detected. On the other hand, when the distance between the first image forming part 31 and the pixel 12 is within the adjustment range, a number of electromagnetic waves incident on one pixel 12 increases. As a result, the detection results of the first detector 41 is less susceptible to noise. Therefore, the distance map calculated by the controller 60 has a small distribution as shown in FIG. 12. The controller 60 may measure the distance assuming that a simple plane is the detection object 66, and determine whether the distance between the first image forming part 31 and the pixel 12 is within the adjustment range based on the distribution of the distance data. When the difference between the maximum value and the minimum value of the distance data is less than a predetermined value, the controller 60 may determine that the distance between the first image forming part 31 and the pixel 12 is within the adjustment range.

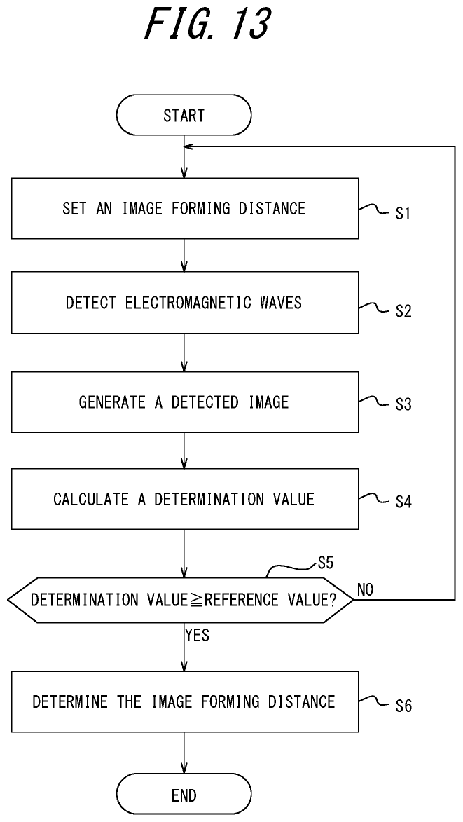

The electromagnetic wave detecting device 1 may be adjusted by an adjustment method including the procedure of the flowchart illustrated in FIG. 13. The adjustment method may include a procedure executed by the operator and a procedure executed by the electromagnetic wave detecting device 1.

The operator sets the distance (image forming distance) between the first image forming part 31 and the traveling part 10 (step S1). The electromagnetic wave detecting device 1 may have a configuration to change the image forming distance. In this case, the electromagnetic wave detecting device 1 may set the image forming distance.

The first detector 41 detects the electromagnetic waves emitted from the detection object 66 (step S2). The chart 70 may be used as the detection object 66. The controller 60 may synchronize the detection of the electromagnetic waves by the first detector 41 with the transition of the state of each pixel 12 in the traveling part 10.

The controller 60 acquires the detection results of the electromagnetic waves from the first detector 41 and generates the detected image 74 (step S3). The controller 60 does not have to execute the procedure in step S3.

The controller 60 calculates a determination value based on the detection results of the electromagnetic waves by the first detector 41 (step S4). When generating the detected image 74 according to the procedure in step S3, the controller 60 may calculate the contrast of at least a part of the region of the detected image 74 as a determination value.

The controller 60 determines whether the determination value is greater than or equal to the reference value (Step S5). The controller 60 may set a reference value corresponding to the detection object 66 in advance. If the determination value is not greater than or equal to the reference value (Step S5: NO), the controller 60 returns to the procedure in step S1. In the procedure of step S1, the operator or the electromagnetic wave detecting device 1 changes the image formation distance.

When the determination value is equal to or greater than the reference value (step S5: YES), the controller 60 determines based on the set image forming distance (step S6). After the procedure in step S6, the procedure of the flowchart in FIG. 13 ends.

The present disclosure has been described based on the drawings and examples, but it should be noted that those skilled in the art will find it easy to make various variations or modifications based on the present disclosure. Therefore, it should be noted that these variations or modifications are included in the scope of the present disclosure. For example, the functions and the like included in each functional part can be rearranged in a logically consistent manner. The plurality of functional parts and the like may be combined or divided into one. Each of the embodiments according to the present disclosure described above is not limited to faithful implementation of the each described embodiments, and may be implemented by combining or omitting some of the features as appropriate.

The descriptions such as “first” and “second” in the present disclosure are identifiers for distinguishing the configuration. The configurations distinguished by the descriptions such as “first” and “second” in the present disclosure can exchange numbers in the configurations. For example, the first image forming part can exchange the identifiers “first” and “second” with the second image forming part. The exchange of identifiers takes place at the same time.

The configuration is still distinguished after the exchange of identifiers. The identifier may be deleted. The configuration in which the identifier is deleted is distinguished by a sign. Based solely on the description of identifiers such as “first” and “second” in the present disclosure, it shall not be used as a basis for interpreting the order of the configurations and for the existence of identifiers with smaller numbers.

### REFERENCE SIGNS LIST

1 Electromagnetic wave detecting device
2 Control device
10 Traveling part
11 Reference plane
12 (12a, 12b) Pixel
30 Traveling axis
30a, 30b, 30c, 30d Spreading range
31 First image forming part
32 Second image forming part
33 Third image forming part
41 First detector
41a First detecting plane
42 Second detector
42a Second detecting plane
50 Separator
60 Controller
62 Emitter
64 Scanner
66 Detection object
70 Chart
72 Determination pattern
74 Detected image
76 Detection pattern
100 Information acquiring system

1. A method for adjusting an electromagnetic wave detecting device comprising:
a first image forming part configured to form an image of electromagnetic waves incident from a detection object;
a traveling part including a reference plane and configured to cause electromagnetic waves incident from the first image forming part to the reference plane to travel in a first direction; and
a first detector configured to detect electromagnetic waves having traveled in the first direction,
the method includes:
changing an image formation distance that is a distance between the first image forming part and at least a part of the reference plane;
detecting electromagnetic waves traveling in the first direction by the first detector at the changed image formation distance;
calculating a determination value based on detection results in the detecting; and
adjusting a position of the first image forming part and the traveling part based on the image formation distance when the determination value becomes equal to or higher than a reference value.

2.-3. (canceled)

4. The method for adjusting an electromagnetic wave detecting device, according to claim 1,
wherein in the detecting, distance information to the one point is detected as the detection results based on electromagnetic waves incident from the one point included in the detection object.

5. The method for adjusting an electromagnetic wave detecting device, according to claim 1,
wherein in the detecting, distance information to each of the plurality of points is detected as the detection results based on electromagnetic waves incident from each of the plurality of points included in the detection object.

6.-7. (canceled)

8. The method for adjusting an electromagnetic wave detecting device, according to claim 1,
wherein the detection object includes a specific pattern.

9. The method for adjusting an electromagnetic wave detecting device, according to claim 1,
wherein the detection object includes a plane.

10. The method for adjusting an electromagnetic wave detecting device, according to claim 1,
wherein the traveling part comprises a plurality of pixels located along the reference plane, and
each of the pixels transitions to either a first state configured to cause electromagnetic waves incident from the first image forming part to the reference plane to travel in a first direction or a second state configured to cause electromagnetic waves to travel in a second direction different from the first direction, and
the method further includes causing electromagnetic waves incident from at least one point included in the detection object to travel in a first direction by causing each of the pixels to transition either one of the first state or the second state.

11.-21. (canceled)

22. The method for adjusting an electromagnetic wave detecting device, according to claim 10, comprising a second detector configured to detect electromagnetic waves having traveled in the second direction.

23.-25. (canceled)

26. The method for adjusting an electromagnetic wave detecting device, according to claim 22, further comprising an emitter configured to emit electromagnetic waves toward a detection object of the first detector and the second detector.

27. The method for adjusting an electromagnetic wave detecting device, according to claim 26,
wherein the emitter comprises a first emitter and a second emitter,
the first detector detects reflected waves of electromagnetic waves emitted from the first emitter, and
the second detector detects reflected waves of electromagnetic waves emitted from the second emitter.

28. The method for adjusting an electromagnetic wave detecting device, according to claim 26,
wherein the first detector and the second detector detect reflected waves of electromagnetic waves emitted from the same emitter.

29.-30. (canceled)

31. The method for adjusting an electromagnetic wave detecting device, according to claim 26,
wherein the emitter further comprises a scanner configured to scan electromagnetic waves emitted by the emitter.

32.-33. (canceled)

34. An electromagnetic wave detection device,
wherein a position of the first image forming part and the traveling part is adjusted by the method for adjusting an electromagnetic wave detecting device, according to claim 1.

35.-37. (canceled)

38. The method for adjusting an electromagnetic wave detecting device, according to claim 1,
wherein the electromagnetic wave detection device comprises:
an emitter configured to emit electromagnetic waves toward the detection object,
a plurality of pixels located along the reference plane, each of the pixels transits to either a first state configured to cause reflecting electromagnetic waves emitted from the emitter and reflected on the detection object to travel in a first direction or a second state configured to cause the reflecting electromagnetic waves not to travel in the first direction different from the first direction, and
a controller configured to calculate a distance from the electromagnetic wave detection device to the detection object based on detecting of reflecting electromagnetic waves detected by the first detector, intensity of the reflecting electromagnetic waves is equal to or higher than a predetermined value,
wherein in the calculating step, the determination value is calculated base on the distance calculated by the controller.

39. The method for adjusting an electromagnetic wave detecting device, according to claim 1, wherein
the detection object includes a first region located at a first distance from the electromagnetic wave detecting device and a second region located at a second distance from the electromagnetic wave detecting device,
in the calculating step, the determination value is calculated based on a number of a detected distance in the detection step.

40. The method for adjusting an electromagnetic wave detecting device, according to claim 1, wherein
the electromagnetic wave detection device comprises a scanner configured to scan electromagnetic waves emitted by the emitter,
the controller is configured to cause the pixels on which the reflecting electromagnetic waves incident to transit to the first state,
in the calculating step, the determination value is calculated based on a distribution of a result obtained by associating the pixels with a plurality of distances calculated in the calculating step.
